(19) United States
(12) Patent Application Publication
(10) Pub. No.: US 2006/0061720 A1
(43) Pub. Date: Mar. 23, 2006

(54) Flexoelectric liquid crystal displays

(76) Inventors: Wei-Chou Chen, Hsinchu City (TW); Kei-Hsiung Yang, Taoyuan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/990,804

(22) Filed: Nov. 17, 2004

(30) Foreign Application Priority Data
Sep. 23, 2004 (TW) 93128822

(51) Int. Cl. G02F 1/1337

(52) U.S. Cl. 349/129

(57) ABSTRACT

Flexoelectric liquid crystal displays. A flexoelectric liquid crystal display has a first substrate, a second substrate parallel to the first substrate, a common electrode region, a pixel electrode region, and a liquid crystal layer disposed between the first and second substrates. The common electrode region is disposed on the first substrate and connected to the liquid crystal layer. The pixel electrode region is disposed on the second substrate and connected to the liquid crystal layer. Two electrical fields of equal magnitude in opposite directions are generated between the common and pixel electrode regions.

### BACKGROUND

The invention relates in general to a flexoelectric liquid crystal displays and in particular to multi-domain flexoelectric liquid crystal displays capable of reducing response time and preventing color shift.

Advanced Super In Plane Switching (AS-IPS) and Multi-domain Vertical Alignment (MVA) technologies have been applied in conventional nematic liquid crystal displays, thereby facilitating wide viewing angles. As disclosed in U.S. Pat. No. 6,483,566, a 2-domain IPS technology is provided to compensate for color shift in conventional liquid crystal displays by forming electrodes thereof in substantially zigzag or bent shapes.

Instead of conventional nematic liquid crystal displays, as disclosed in U.S. Pat. No. 4,917,475, a flexoelectric liquid crystal device with wide viewing angle and high response rate has been provided to meet LCD-TV requirements. As shown in FIG. 1a, the flexoelectric liquid crystal device comprises a liquid crystal layer L disposed between parallel electrodes E1 and E2. Electrodes E1 and E2 produce an electrical field E, thereby re-arranging the liquid crystal molecules in the liquid crystal layer L with flexoelectric effect exhibited therein.

Referring to FIGS. 1a, 1b and 1c, the liquid crystal molecules in a flexoelectric liquid crystal device form a helix with an axis Z essentially parallel to electrodes E1 and E2. As electrodes E1 and E2 produce an electrical field E parallel to the X axis, helix axis Z in the liquid crystal layer L rotates at an angle θ around the X axis from the position shown in FIG. 1b to the position shown in FIG. 1c. More specifically, the helix axis Z is always perpendicular to the direction of electrical field E (X direction) and the direction of the liquid crystal molecules (M direction). Based on the characteristics of the liquid crystal molecules and the flexoelectric effect, the intensity of electrical field E between the electrodes E1 and E2 is used to control the helix axis Z rotating at an appropriate angle thus facilitating wide viewing angle of the flexoelectric liquid crystal device. Conventional 2-domain IPS technology with zigzag or bent electrodes, however, is not easily practiced in a flexoelectric liquid crystal device to achieve color shift compensation as the specific molecular structure and characteristics are different from nematic liquid crystal. It is an important issue to improve color shift compensation of a flexoelectric liquid crystal device.

### SUMMARY

Multi-domain flexoelectric liquid crystal displays are provided. An exemplary embodiment of a flexoelectric liquid crystal display comprises a first substrate, a second substrate parallel to the first substrate, a common electrode region, a pixel electrode region, and a liquid crystal layer disposed between the first and second substrates. The common electrode region is disposed on the first substrate and connected to the liquid crystal layer. The pixel electrode region is disposed on the second substrate and connected to the liquid crystal layer. Two electrical fields of equal magnitude in opposite directions are generated between the common and pixel electrode regions.

### DESCRIPTION OF THE DRAWINGS

FIG. 1a is a perspective diagram of a conventional flexoelectric liquid crystal device;

FIGS. 1b and 1c are perspective diagrams of liquid crystal molecules forming a helix in a conventional flexoelectric liquid crystal device;

FIG. 2 is a perspective diagram of an exemplary embodiment of a flexoelectric liquid crystal device;

FIG. 3 is a perspective diagram of an exemplary embodiment of a flexoelectric liquid crystal device;

FIG. 4 is a perspective diagram of an exemplary embodiment of a flexoelectric liquid crystal device; and

FIG. 5 is a perspective diagram of TFT (Thin-Film Transistor) driving circuits employed in the flexoelectric liquid crystal device of FIG. 2.

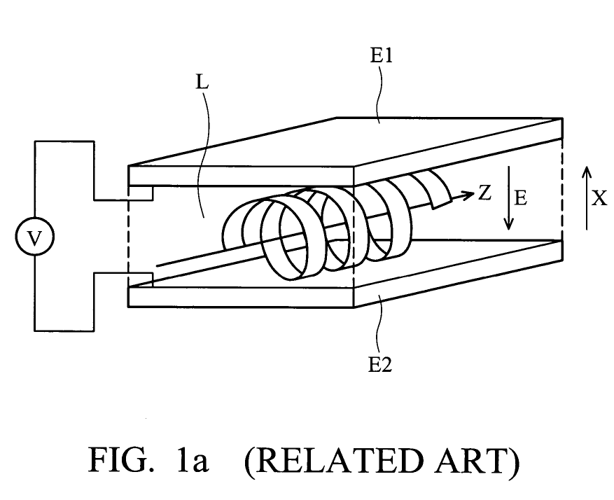

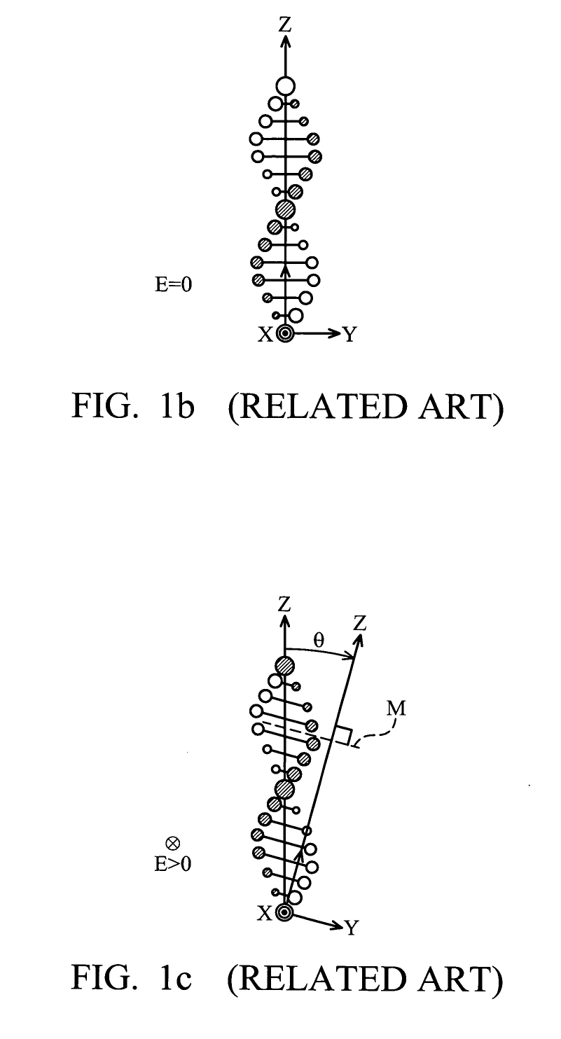

### DESCRIPTION

An embodiment of multi-domain flexoelectric liquid crystal display comprises two parallel substrates comprising electrodes. At least one of the substrates comprises a plurality of electrodes disposed thereon, capable of producing two equal electrical fields between the substrates in opposite directions to prevent color shift.

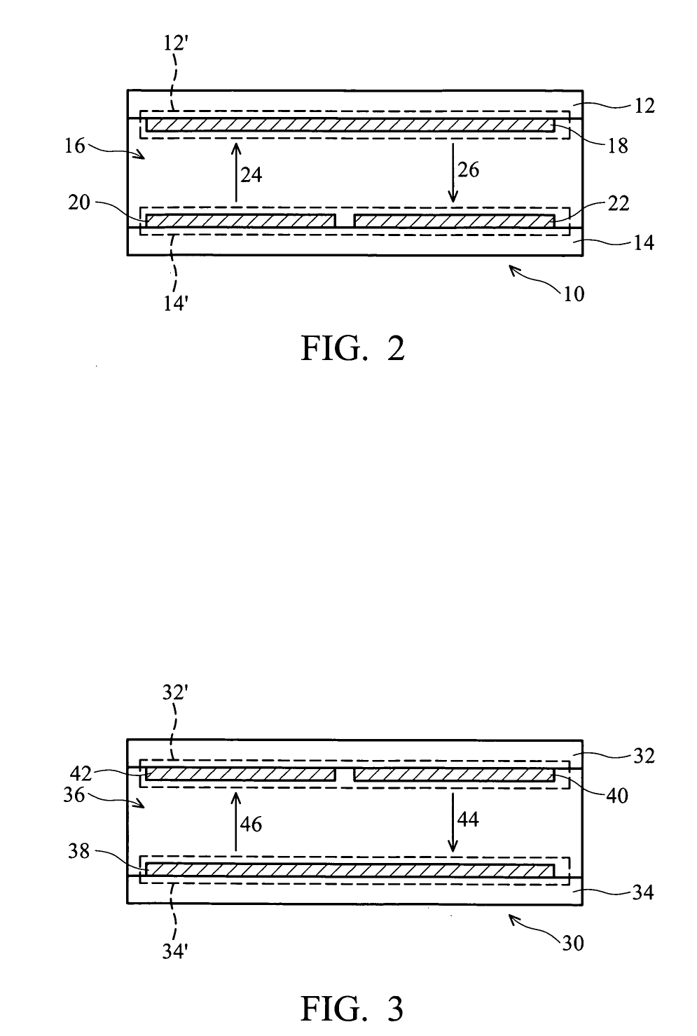

Referring to FIG. 2, an embodiment of a pixel element 10 in a the flexoelectric liquid crystal display comprises a first substrate 12, a second substrate 14, a liquid crystal layer 16, a common electrode region 12′ and a pixel electrode region 14′. The first and second substrates 12 and 14 are parallel to each other with the liquid crystal layer 16 disposed therebetween.

The common electrode region 12′ comprises a first electrode 18 disposed on the first substrate 12. The pixel electrode region 14′ comprises a second electrode 20 and a third electrode 22 disposed on the second substrate 14. As shown in FIG. 2, the first electrode 18 having a first potential V1 is disposed on the surface beneath the first substrate 12 and connected to the liquid crystal layer 16. The second and third electrodes 20 and 22, having second and third potentials V2 and V3 respectively, are disposed on the upper surface of the second substrate 14 and connected to the liquid crystal layer 16. More specifically, the first potential V1 is the average of the second and third potentials V2 and V3, that is, V2-V1=V1−V3.

In some embodiments, when the second electrode 20 is grounded (V2=0), the third potential V3 is twice the first potential V1 (V3=2V1). In some embodiments, when first electrode 18 is grounded (V1=0), the second and third potentials V2 and V3 have equal magnitudes, wherein one is positive and the other is negative (V2=−V3). Thus, two electrical fields 24 and 26 of equal magnitude in opposite directions are produced between the common and pixel electrode regions 12′ and 14′, and helix axis of liquid crystal molecules in the liquid crystal layer 16 rotates to prevent color shift.

Referring to FIG. 3, an embodiment of a pixel element 30 of the flexoelectric liquid crystal display comprises a first substrate 32, a second substrate 34, a liquid crystal layer 36, a common electrode region 32′ and a pixel electrode region 34′. The first and second substrates 32 and 34 are parallel to each other with the liquid crystal layer 36 disposed therebetween.

The pixel electrode region 34′ comprises a first electrode 38 disposed on the second substrate 34. The common electrode region 32′ comprises a second electrode 40 and a third electrode 42 disposed on the first substrate 32. As shown in FIG. 3, the first electrode 38 having a first potential V1 is disposed on the upper surface of the second substrate 34 and connected to the liquid crystal layer 36. The second and third electrodes 40 and 42, having second and third potentials V2 and V3 respectively, are disposed on the surface beneath the second substrate 34 and connected to the liquid crystal layer 36. Particularly, the potential V1 is the average of the second and third potentials V2 and V3, that is, V2−V1=V1−V3.

In some embodiments, when the second electrode 40 is grounded (V2=0), the third potential V3 is twice the first potential V1 (V3=2V1). In some embodiments, when the first electrode 38 is grounded (V1=0), the second and third potentials V2 and V3 have equal, but reverse magnitudes, with respect to the first potential V1. Thus, two electrical fields 44 and 46 of equal magnitude in opposite directions are produced between the common and pixel electrode regions 32′ and 34′, and helix axis of liquid crystal molecules in the liquid crystal layer 16 rotates to prevent color shift.

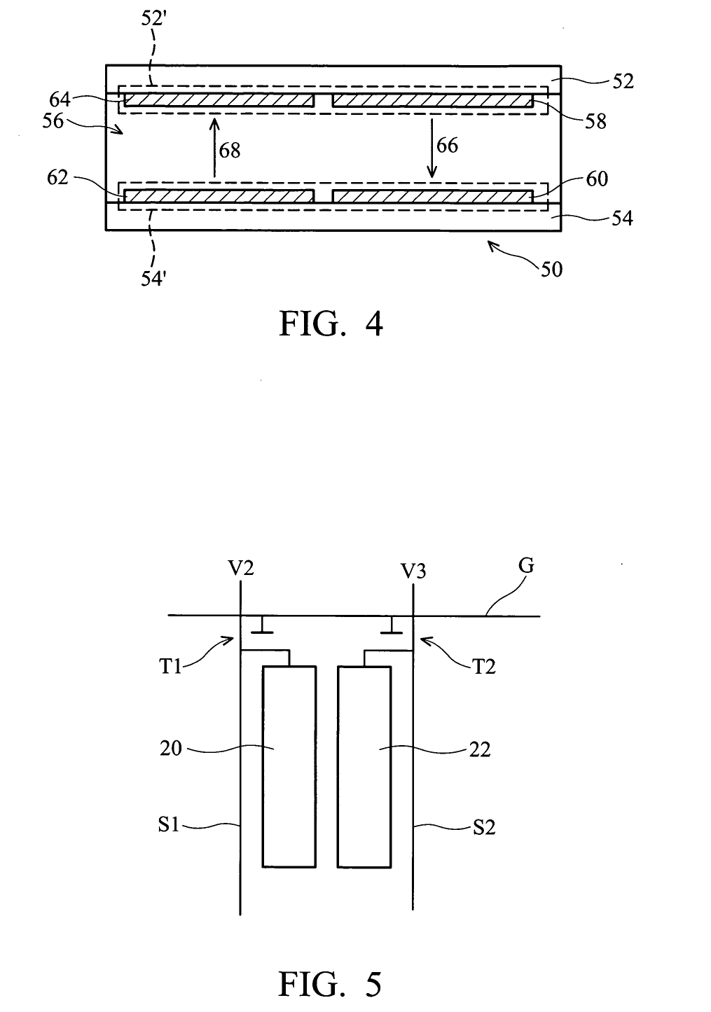

Referring to FIG. 4, an embodiment of a pixel element 50 of the flexoelectric liquid crystal display comprises a first substrate 52, a second substrate 54, a liquid crystal layer 56, a common electrode region 52′ and a pixel electrode region 54′. The first and second substrates 52 and 54 are parallel to each other with the liquid crystal layer 56 disposed therebetween.

The common electrode region 52′ comprises a first electrode 58 and a fourth electrode 64 disposed on the first substrate 52. The pixel electrode region 54′ comprises a second electrode 60 and a third electrode 62 disposed on the second substrate 54. As shown in FIG. 4, the first and fourth electrodes 58 and 64, having a first potential V1 and a fourth potential V4 respectively, are disposed on the surface beneath the first substrate 52 and connected to the liquid crystal layer 56. The second and third electrodes 60 and 62, having second and third potentials V2 and V3 respectively, are disposed on the upper surface of the second substrate 54 and connected to the liquid crystal layer 56. More specifically, the electric potential difference of the first and second electrodes 58 and 60 is equal to that of the third and fourth electrodes 62 and 64, that is, V2−V1=V4−V3.

In some embodiments, when the second and fourth electrodes 60 and 64 are grounded (V2=V4=0), the first potential is equal to the third potential V3 (V1=V3). In some embodiments, when the first and fourth electrodes 58 and 64 are grounded (V1=V4=0), the second and third potentials V2 and V3 have equal magnitudes, wherein one is positive and the other is negative (V2=−V3). Thus, two electrical fields 66 and 68 of equal magnitude in opposite directions are produced between the common and pixel electrode regions 52′ and 54′, and helix axis of liquid crystal molecules in the liquid crystal layer 56 rotates to prevent color shift.

Referring to FIGS. 2 and 5, TFT (Thin-Film Transistor) driving circuits are employed to drive the pixel element 10 of a flexoelectric liquid crystal display, such as a TFT-LCD. As shown in FIG. 5, a first thin-film transistor T1 and a second thin-film transistor T2 are disposed in the pixel element 10 of FIG. 2. The gates of the first and second thin-film transistors T1 and T2 are connected and controlled by gate line G. The drains of the first and second thin-film transistors T1 and T2 respectively connect the second and third electrodes 20 and 22 of FIG. 2. Further, a first source line S1 and a second source line S2 respectively connect the sources of the first and second thin-film transistors T1 and T2, thereby providing the second and third potentials V2 and V3 to the second and third electrodes 20 and 22.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A flexoelectric liquid crystal display, comprising a plurality of pixel elements, each pixel element comprising:
a first substrate;
a second substrate parallel to the first substrate;
a liquid crystal layer, disposed between the first and second substrates;
a common electrode region disposed on the first substrate and connected to the liquid crystal layer; and
a pixel electrode region disposed on the second substrate and connected to the liquid crystal layer, wherein two electrical fields of equal magnitude in opposite directions are generated between the common electrode region and the pixel electrode region.

2. The flexoelectric liquid crystal display as claimed in claim 1, wherein the common electrode region comprises a first electrode with a first potential, the pixel electrode region comprises a second electrode with a second potential and a third electrode with a third potential, and the first potential is the average of the second and third potentials.

3. The flexoelectric liquid crystal display as claimed in claim 2, wherein the first electrode is grounded, and the second and third potentials have equal magnitudes but opposite signals.

4. The flexoelectric liquid crystal display as claimed in claim 2, wherein the second electrode is grounded, and the third potential is twice the first potential.

5. The flexoelectric liquid crystal display as claimed in claim 1, wherein the common electrode region comprises a first electrode and a fourth electrode, the pixel electrode region comprises a second electrode and a third electrode opposite to the first and fourth electrodes respectively, and the electric potential difference of the first and second electrodes is equal to that of the third and fourth electrodes, thereby producing the two electrical fields of equal magnitude in opposite directions.

6. The flexoelectric liquid crystal display as claimed in claim 2 is a TFT-LCD.

7. The flexoelectric liquid crystal display as claimed in claim 6 further comprising a first thin-film transistor connecting the second electrode and a second thin-film transistor connecting the third electrode for providing the second and third potentials to the second and third electrodes respectively.

8. The flexoelectric liquid crystal display as claimed in claim 7, wherein a gate line electrically connects both gates of the first and second thin-film transistors, and each source of the first and second thin-film transistors respectively connects to a first source line and a second source line.

9. The flexoelectric liquid crystal display as claimed in claim 1, wherein the pixel electrode region comprises a first electrode with a first potential, the common electrode region comprises a second electrode with a second potential and a third electrode with a third potential, and the first potential is the average of the second and third potentials.

10. The flexoelectric liquid crystal display as claimed in claim 9, wherein the first electrode is grounded, and the second and third potentials have equal magnitudes but opposite signals.

11. The flexoelectric liquid crystal display as claimed in claim 9, wherein the second electrode is grounded, and the third potential is twice the first potential.
